(19) United States
(12) Patent Application Publication
(10) Pub. No.: US 2022/0152968 A1
(43) Pub. Date: May 19, 2022

(54) APPARATUS FOR DIE FILLING

(71) Applicant: Kerry Johanson, Gainesville, FL (US)

(72) Inventor: Kerry Johanson, Gainesville, FL (US)

(21) Appl. No.: 16/950,243

(22) Filed: Nov. 17, 2020

(51) Int. Cl. B30B 15/30; A61J 3/10; B30B 11/02

(52) U.S. Cl. CPC B30B 15/304; B30B 11/027; A61J 3/10

(57) ABSTRACT

The invention presented is a die filling apparatus that includes a unique powder feed assembly that includes a novel plurality of vertically stacked drive gear-feed gear pairs that move filling powder through a series of sieves into a die used for compressing powder into a tablet. At least the bottom feed gear includes a plurality of logarithmic vanes or blades with an offset axis of rotation. Also presented is a method to fabricate pellets from powder using an apparatus to form a pellet.

### FIELD OF THE INVENTION

The field of the invention relates generally to manufacture of chemical or pharmaceutical products, more specifically to manufacture of tablets from chemical and pharmaceutical powders and still more specifically to the use of dies to produce tablets from commercial chemical and pharmaceutical powders.

### BACKGROUND OF THE INVENTION

Powders are a common type of product that can be manufactured from various types of materials such as organic chemicals and inorganic materials, for example the chemicals found in pharmaceutical products such as thyroxine tablets and metallic or salt mixture powders such as powders used in the manufacture of thermal batteries and ceramic substrates found in electronics.

Powder(s) are often formed into a tablet that is a convenient form for handling a powder both for delivery of a product such as aspirin to a patient or a repeatable specific quantity of a metallic powder such as lithium for a thermal battery manufacturer. However, there are some inherent problems in the manufacture of tablets, especially in the fabrication of tablets used, for example, in the pharmaceutical and high technology industries. In such industries, repeatable uniformity of the content of each tablet is extremely important. Cavitation of the powder as the tablet is formed can defeat uniformity by forming air pockets within a tablet and/or producing tablets in which the total quantity of powder is below or above acceptable ranges for the specific tablet.

In the prior art, Korean patent KR101854806 (Woo) discloses a stack of feed impellers that feeds powder to compression assemblies such as die filling apparatuses. However, there is no provision for preparing the powder to prevent cavitation during tablet formation. In addition, the '806 patent discloses only radial symmetric impellers which would allow buildup of powder caught directly under the axes of rotation of the impellers. U.S. Pat. No. 9,067,377 (Dickinger et al.) discloses a single rotating blade to move powder to a compression apparatus. However, there is no component to reduce or eliminate cavitation to ensure uniformity and the several impeller embodiments are all radially symmetrical. Korean Patent No. KR101615331 (Kang Seok Jin, et al.), International Patent Publication No. WO2015186905 (Woo Jongsoo, et al.), and Korean Patent No. KR101288210 (Hew Young Kim) are a few other examples of the prior art that teach the use of impellers in tablet forming machines, but all lack any device to ensure tablet uniformity or prevent powder buildup within the impeller assemblies.

Therefore, it can be seen that there is a need in the field for a device or apparatus that can ensure powder uniformity in powders moved to die filling assemblies.

### SUMMARY OF THE INVENTION

The present invention broadly comprises a powder feed assembly comprising: a plurality of drive gear-feed gear pairs, wherein in each of the pairs the drive gear is operatively attached to the feed gear; a plurality of housing covers-housings assemblies wherein each of the plurality of housing covers-housings assemblies holds one of the plurality of drive gear-feed gear pairs and wherein each one of the plurality of housing covers-housings assemblies are stacked one above the other; at least one sieve housing holding a sieve wherein the housing is stacked under a bottom one of the housings; and, a powder feed power drive operatively attached to each of the drive gears. In one embodiment, the powder feed assembly is mounted on a base defining at least one die hole.

The present invention also broadly comprises an apparatus for die filling with a powder comprising: a powder dispensing assembly including: a feed hopper to receive a supply of powder; a powder feed device operatively attached to the feed hopper; a dispensing drive mechanism operatively attached to the powder feed device; and a powder feed assembly that includes: a plurality of drive gear-feed gear pairs, wherein in each of the pairs each drive gear is operatively attached to the feed gear; a plurality of housing covers-housings assemblies wherein each of the plurality of housing covers-housings assemblies holds one of the plurality of drive gear-feed gear pairs and wherein each one of the plurality of housing covers-housings assemblies are stacked one above the other; at least one sieve housing holding a sieve wherein the housing is attached to one of the housings; and, a powder feed power drive operatively attached to each of the drive gears. The apparatus also includes a die; and, at least one press. The at least one press forms the received powder into the die to form a pellet. A top feed gear receives powder from the dispensing drive mechanism and the feed gears feed the powder to a succeeding feed gear. The at least one die receives powder from the at least one sieve. The apparatus is mounted on a base, the base defining at least one die hole.

The present invention also broadly comprises a method for fabricating a pellet from a powder utilizing the apparatus broadly described above, the method comprising: dispensing a known quantity of powder from the powder dispensing assembly into a feed orifice in the top housing of the assembly of housings; rotating each of the plurality of drive gear-feed gear pairs in both a counterclockwise and clockwise direction; driving the known quantity of powder through a first sieve into the feed gear of a second drive gear-feed gear pair, the second feed gear positioned under the first sieve; repeating the rotation of each of the plurality of drive gear-feed gear pairs in both a counterclockwise and clockwise direction; driving the known quantity of powder through a second sieve into the feed gear of a third drive gear-feed gear pair, the third feed gear positioned under the second sieve; repeating the rotation of each of the plurality of drive gear-feed gear pairs in both a counterclockwise and clockwise direction; driving the known quantity of powder to at least one lower die positioned under the bottom feed gear; pulling the apparatus from directly above the at least one die using the ram system; pressing an upper die against the lower die to form a pellet; raising the lower die/press carrying the pellet; and pushing the apparatus to directly above the at least one lower die and simultaneously pushing the formed pellet into a receptacle.

An object of the invention is to supply a die filling apparatus that ensures a uniform powder is filled into one or more dies consistently.

A second object of the invention is to provide a powder feed assembly that ensures the reduction of powder buildup under the feed gears pushing powder to the die(s).

A third object of the invention is to offer a method of filling dies used to compress powder into a tablet.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a top perspective view of the die filling apparatus of the present invention;

FIG. 2 is a close-up top perspective view of the powder feed mechanism first seen is FIG. 1;

FIG. 3 is a top perspective view of the housings-housing cover assemblies with the cover removed;

FIG. 4 is a close-up top perspective view of the top housing of the stacked housing cover-housing assemblies with the first housing cover removed;

FIG. 5 depicts the top gear pair with the first housing removed showing the top gear pair resting on top of the second housing cover;

FIG. 6 completely displays the top sieve which is located directly below the top feed gear and is fit or otherwise positioned into the feed hole;

FIG. 7 shows the second gear pair operatively attached to the drive axle and nestled into the second housing;

FIG. 8 depicts the second gear pair with the second housing removed shown resting on top of the third housing cover;

FIG. 9 completely displays the second sieve which is located directly below the second feed gear and is fit or otherwise positioned into the feed hole;

FIG. 10 shows the third gear pair operatively attached to the drive axle and nestled into the third housing;

FIG. 11 depicts the bottom feed gear nestled into a well of the bottom housing;

FIG. 12 is a top perspective view of the bottom feed gear displaced from the powder feed hole and providing a clearer view of the offset arrangement of the vanes; and,

FIG. 13 is a bottom perspective view of the bottom feed gear showing vane extensions that extend below the plane of the bottom surface of the bottom feed gear.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the invention, the preferred methods, devices, and materials are now described.

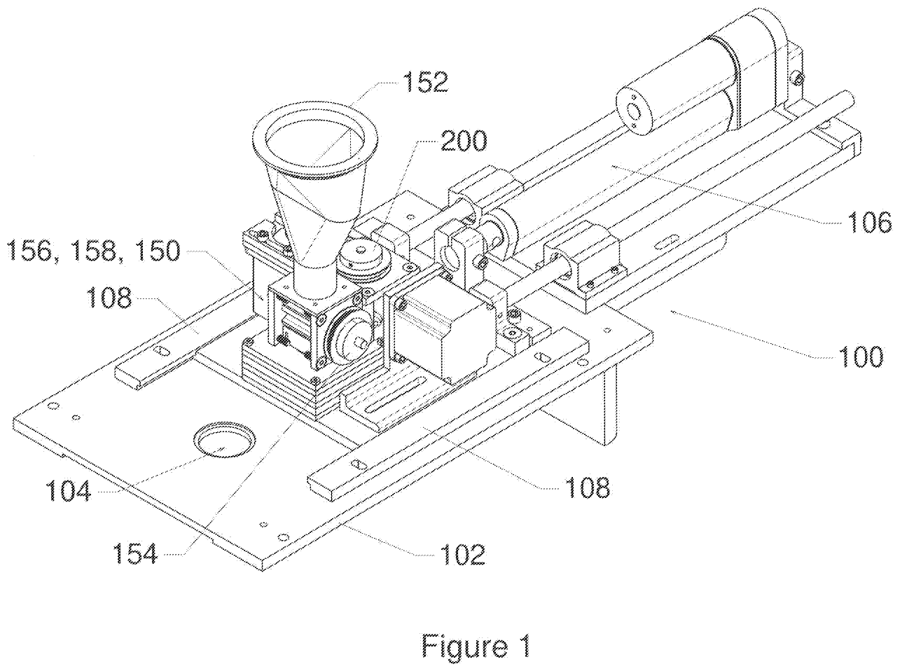

Adverting to the drawings, FIG. 1 is a top perspective view of die filling apparatus 100 (“apparatus 100”) of the present invention. Apparatus 100 is supported by base 102. Base 102 also supports tracks 108 and defines die hole 104. Ram system 106 moves apparatus 100 along tracks 108 alternately over and away from die hole 104 as described below.

Powder dispensing assembly 150 (“dispensing assembly 150”) receives the powder to be formed into pellets and dispenses it to powder feed mechanism 200 (“feed mechanism 200”). Fill hopper 152 (“hopper 152”) receives powder and dispenses a known quantity of the powder to feed assembly 200 positioned directly below hopper 152. Dispensing drive 154 is operatively attached to a powder feed device 156 (shown as a shaded component) located at the bottom of hopper 152 directly over the opening to feed mechanism 200. In the embodiment shown, powder feed device 156 may comprise a plurality of vanes 158 that rotate to supply known quantities of powder to feed mechanism 200.

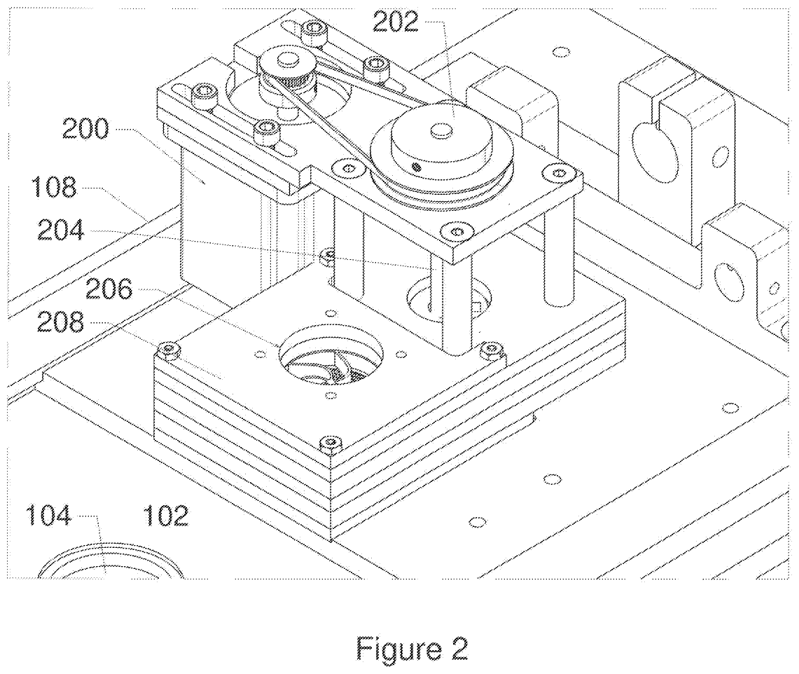

FIG. 2 is a close-up top perspective view of powder feed assembly 200 first seen in FIG. 1. Powder feed drive 202 (“feed drive 202”) is operatively attached to a plurality of drive gear-feed gear pairs (“gear pairs”) (not seen in FIG. 2) by drive axle 204. Powder feed hole 206 (“hole 206”) is defined by housing assembly cover 208 and further defined as a single hole in each of a series of vertically stacked housings-housing cover assemblies 216-219a (collectively “assembly 214”) as described below. By operatively attached is meant that a component or device is connected either directly or indirectly to a second component and causes that second component to function. For example, as described above, drive axle 204 is described as operatively attached or operationally attached to a plurality of drive gear-feed gear pairs meaning drive axle 204 causes each of the gears of the gear pairs to rotate.

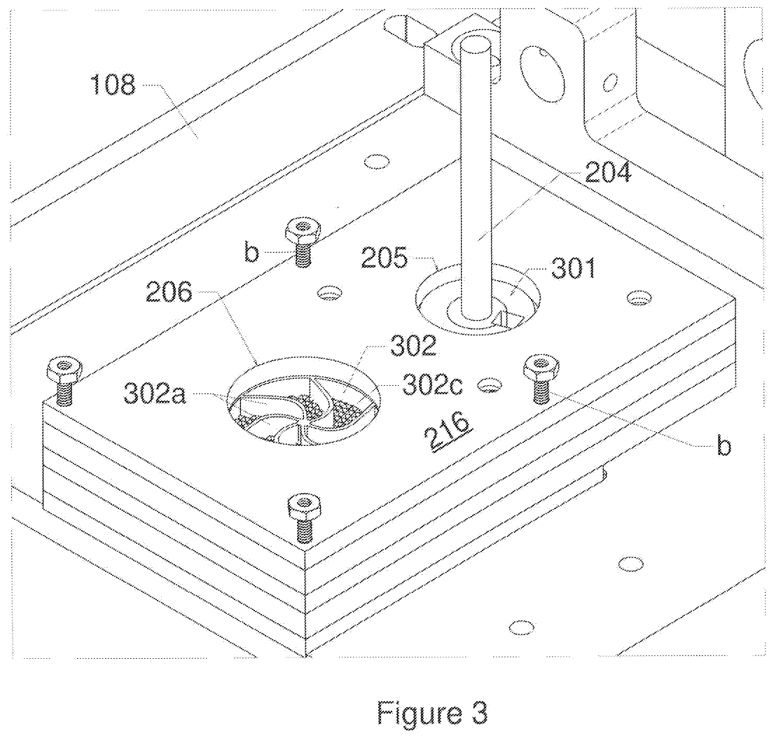

FIG. 3 is a top perspective view of housings-housing cover assemblies 216-219a with housing assembly cover 208 removed. Drive axle 204 is seen extending into drive hole 205 (“hole 205”). Similar to powder feed hole 206, drive hole 205 is formed as a single hole defined by the series of stacked housings cover-housing assemblies 216-219a. Housing cover 216 is the top component of assembly 214. First drive gear 301 can be partially seen through drive hole 205. Also seen is powder feed gear 302 (“feed gear 302”) with a plurality of logarithmic extended vanes 302a. Sieve 302c is seen positioned below feed gear 302. By logarithmic is meant that vanes 302a each have a curved shape bent in the same direction relative to the circular inner wall of gear 302. Vanes 302a join at a common center point that is equidistant from the inner wall. A plurality of nut and bolt assemblies b hold the components of assembly 214 in place.

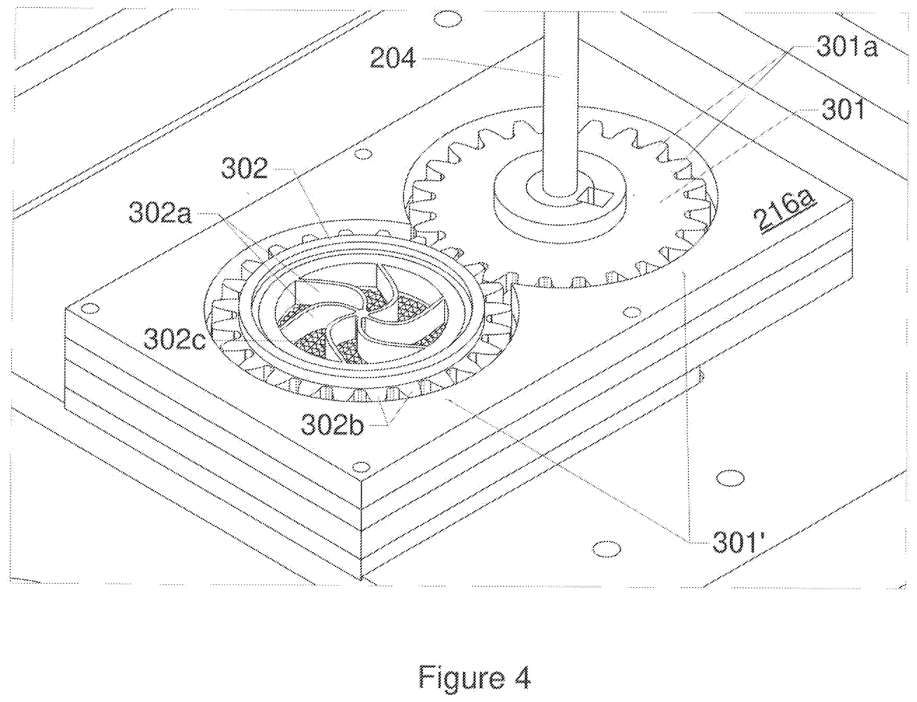

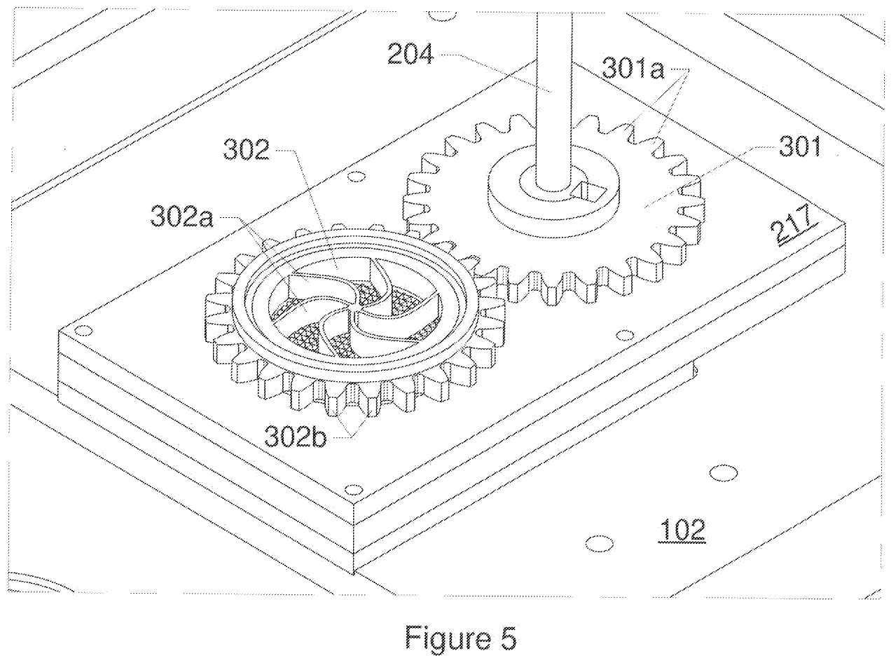

FIG. 4 is a top perspective view of top housing 216a with housing cover 216 removed. Drive gear 301 and feed gear 302 are more completely seen with drive gear teeth 301a interacting with feed gear teeth 302b to form a functional attachment between drive gear-feed gear pair 301′ nestled in housing 216a. By functional attachment is meant that the link i.e., the gear teeth 301a and 302b, allows feed gear 302 to function, that is rotate. It can be seen that the operative attachment of drive axle 204 to drive gear 301 causes both drive gear 301 and feed gear 302 (collectively “gear pair 301”) to rotate demonstrating the operative attachment. FIG. 5 depicts top gear pair 301 with housing 216a removed showing gear pair 301 resting on top of second housing cover 217.

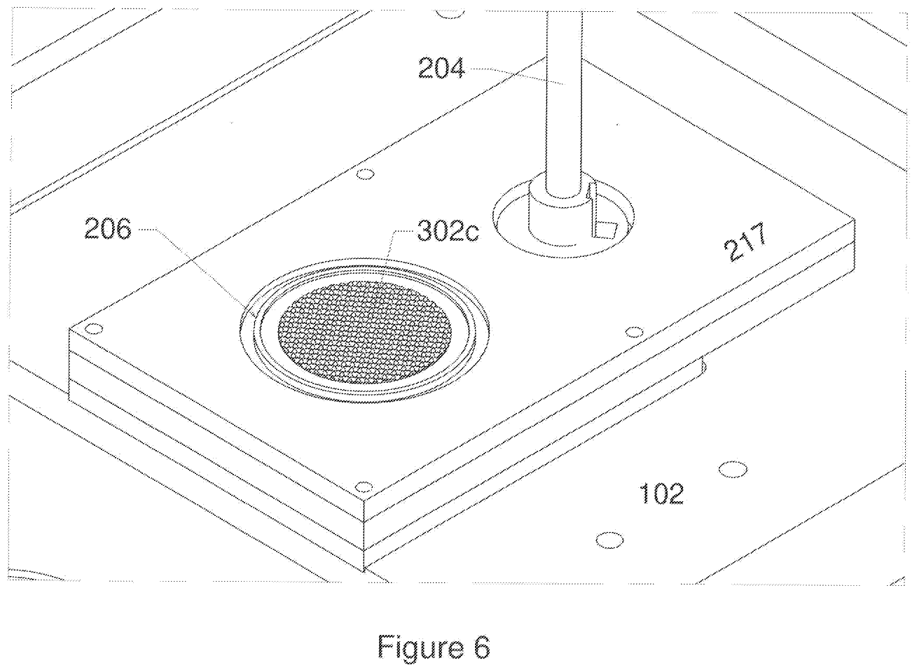

FIG. 6 completely displays sieve 302c with feed gear pair 301′ removed. Sieve 302c is located directly below feed gear 302 as seen above and is fit or otherwise positioned into feed hole 206. As discussed below, the powder is directed from the feed gears through the various sieves into feed hole 206.

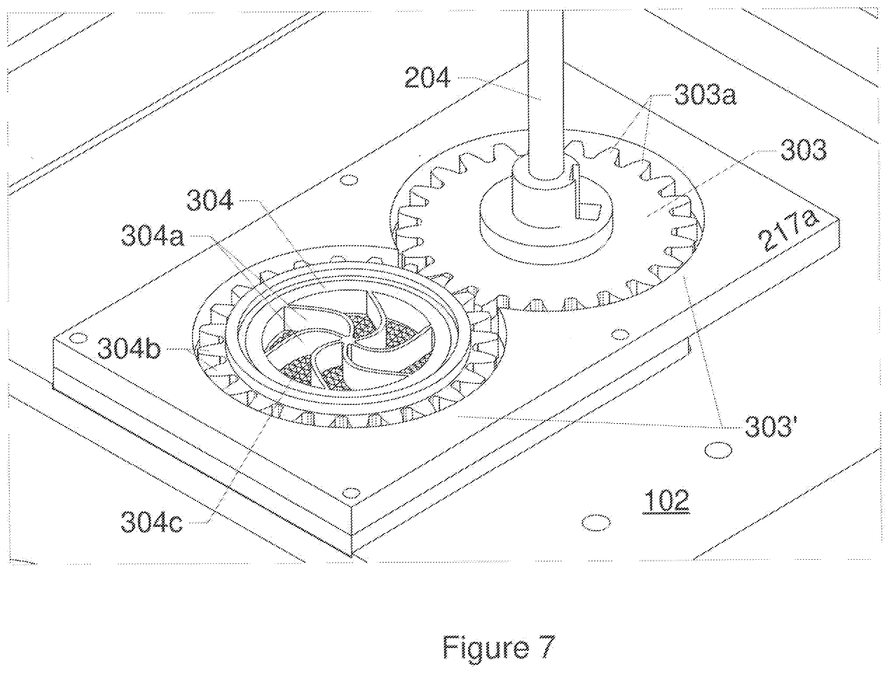

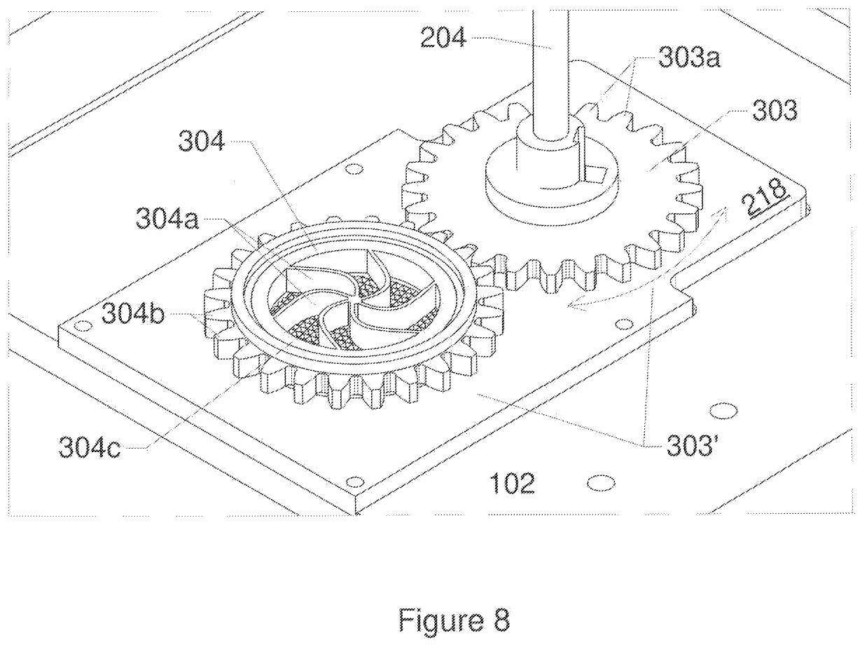

FIG. 7 shows second gear pair 303′ comprising drive gear 303 operatively attached to drive axle 204 and feed gear 304 with both nestled into housing 217a. Similar to gear pair 301′, drive gear 303 is functionally attached through gear teeth 303a and gear teeth 304b to feed gear 304 causing feed gear 304 to rotate. Also seen are logarithmic vanes 304a. By functional attachment is meant that the link between one component and a second component allows the second component to function. For example, the functional attachment between drive gear 303 and feed gear 304, namely gear teeth 303a and 304b enables feed gear 304 to rotate. Sieve 304c is positioned in feed hole 206 directly below feed gear 304. FIG. 8 depicts second gear pair 303′ with housing 217a removed showing gear pair 303′ resting on top of third housing cover 218.

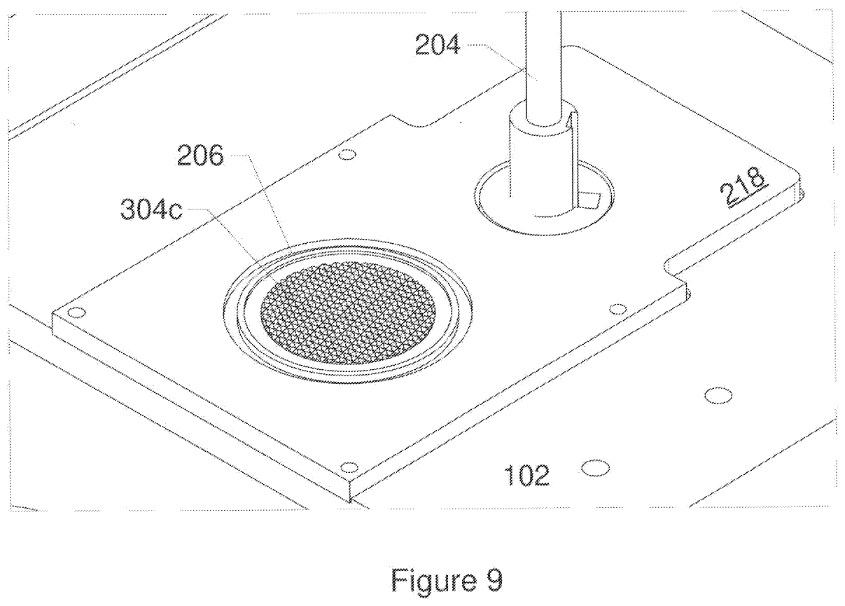

FIG. 9 completely displays sieve 304c with gear pair 303′ removed. Sieve 304c is located directly below feed gear 304 as seen above and is fit or otherwise positioned into feed hole 206.

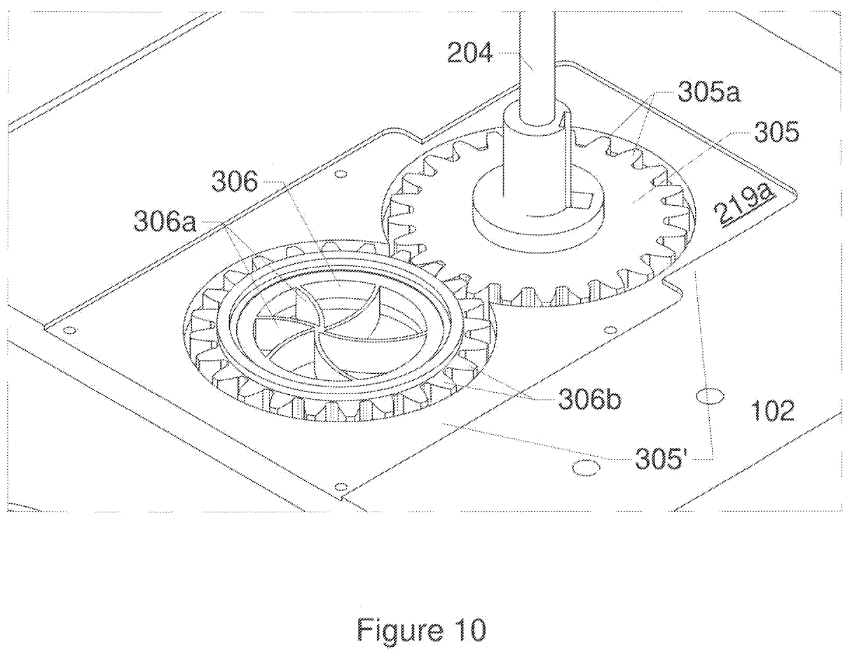

FIG. 10 shows second gear pair 305′ comprising drive gear 305 operatively attached to drive axle 204 and feed gear 306 with both gears nestled into housing 219a. Drive gear 305 is functionally attached through gear teeth 305a and gear teeth 306b to feed gear 306 causing feed gear 306 to rotate. Also seen are logarithmic vanes 306a.

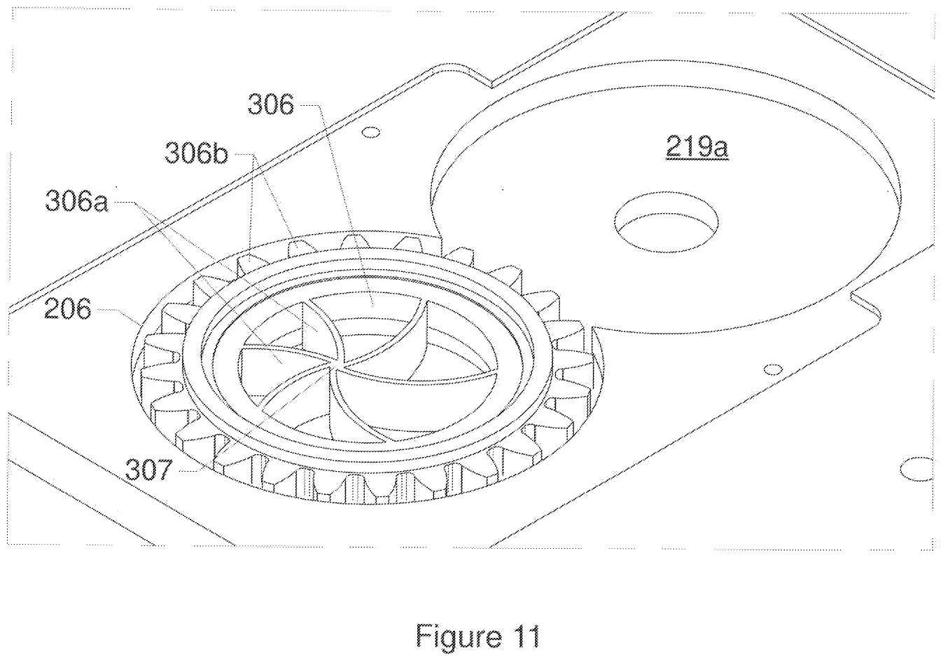

FIG. 11 depicts feed gear 306 nestled into a well of housing 219a. Vanes 306a are in a uniquely offset configuration in that they meet at a point 307 that is offset or removed to a point away from the axial center of feed gear 306. As explained below, in contrast to the upper housings, the offset configuration of vanes 306a provides the advantage of sweeping powder received from sieve 304c to vanes 306a from the complete surface of the well in housing 219a. No powder stays trapped below offset point 307 as it does underneath the axial center point found in feed gears 302 and 304.

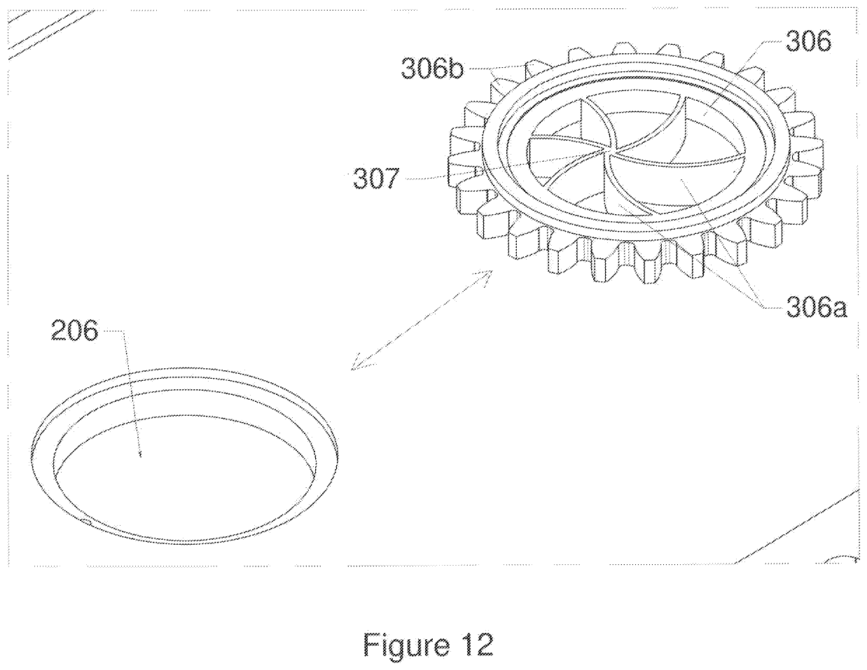

FIG. 12 is a top perspective view of feed gear 306 displaced from powder feed hole 206 and providing a clearer view of the offset arrangement of vanes 306a. As will be described below, the common drive axle 204 rotates each of the gear pairs both clockwise and counter clockwise for each quantity of powder that will make up the pellet. The offset arrangement enables offset point 307 to move laterally relative to the housing floor thereby capturing all the powder to be pushed into feed hole 206. It can be seen that each vane 306a possesses the logarithmic curved shape of feed gears 302 and 304, but in contrast to those feed gears, each of vanes 306a, though joined at a common point, have different overall lengths to create the offset arrangement of those vanes.

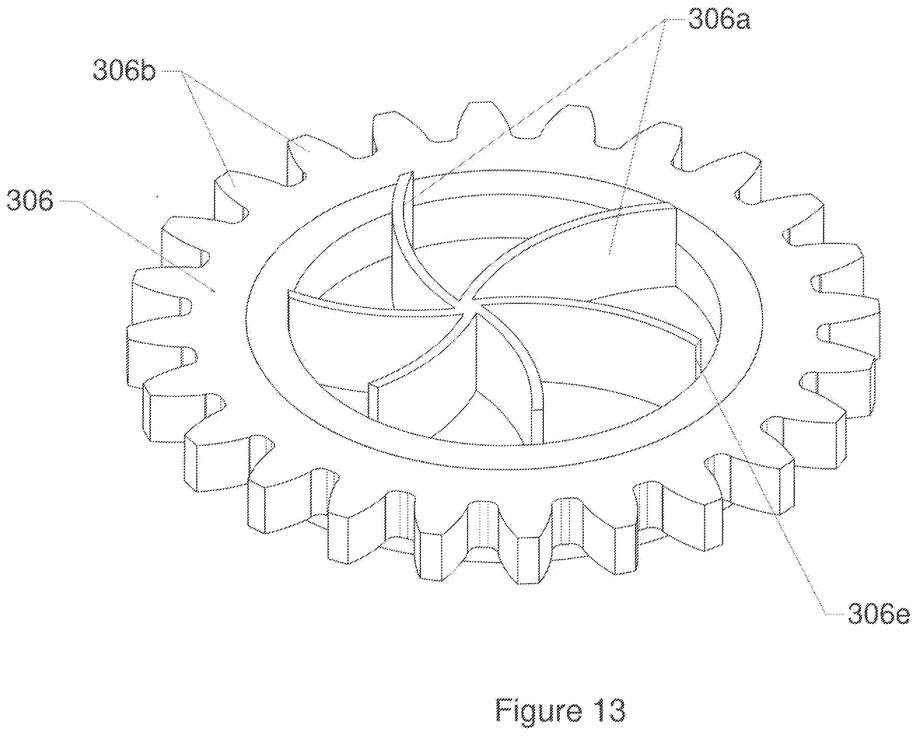

FIG. 13 is a bottom perspective view of feed gear 306 showing the extensions 306e of vanes 306a that extend below the plane of the bottom surface of feed gear 306. Extensions 306e enable feed gear 306 to scrape the powder from the floor of bottom housing 219a without interference from the bottom surface of feed gear 306 itself.

In general, apparatus 100 forms pellets from powder by feeding powder from the feed hopper 152 of powder dispensing assembly 150 to feed assembly 200. Powder is fed in predetermined quantities into feed assembly 200 from powder feed device 156. Preferably, powder feed device 156 is positioned directly over feed hole 206 defined by the vertical stack of the plurality of housing covers-housings, i.e. assemblies 214, to enable the powder to flow using gravity. With assembly 214, the top feed gear receives powder from the dispensing drive mechanism, while each feed gear feeds the powder to the lower succeeding feed gear. The die is positioned below feed hole 206 and receives powder after it passes through at least one sieve.

The method for fabricating pellets comprises at least dispensing a known quantity of powder from the powder dispensing assembly into a feed orifice in the top housing cover 216-housing 216a of the assembly of housings, rotating each of the plurality of drive gear-feed gear pairs 301′, 303′ and 305′ in both a counterclockwise and clockwise direction, driving the known quantity of powder through a first sieve 302c into feed gear 304 of second drive gear-feed gear pair 303′, with second feed gear 304 positioned under first sieve 302c; repeating the simultaneous rotation of 301′, 303′ and 305′ in both a counterclockwise and clockwise direction; driving the known quantity of powder through second sieve 304c into feed gear 306 of third drive gear-feed gear pair 305′, third feed gear 306 positioned under second sieve 304c; rotating 301′, 303′ and 305′ in both a counterclockwise and clockwise direction; driving the known quantity of powder to at least lower one die positioned under the bottom feed gear; pulling the apparatus from directly above the die using ram system 106; pressing an upper die press or die against the lower die to form a pellet; raising the lower die/press carrying the pellet; pushing apparatus 100 to directly above the at least one lower die and simultaneously pushing the formed pellet into a receptacle. In a preferred embodiment, apparatus 100 is pushed to directly above the at least one lower die while simultaneously pushing the formed pellet into a receptacle such as a hopper or conveyor.

Thus, it is seen that the objects of the invention are efficiently obtained, although changes and modifications to the invention should be readily apparent to those having ordinary skill in the art, which changes would not depart from the spirit and scope of the invention as claimed.

I claim:

1. A powder feed assembly comprising:
a plurality of drive gear-feed gear pairs, wherein in each of said pairs each said drive gear is functionally attached to said feed gear;
a plurality of housing covers-housings assemblies wherein each of said plurality of housing covers-housings assemblies holds one of said plurality of drive gear-feed gear pairs and wherein each one of said plurality of housing covers-housings assemblies are stacked one above the other;
at least one sieve housing holding a sieve wherein said housing is stacked under a bottom one of said housings; and,
a powder feed power drive operatively attached to each of said drive gears.

2. The assembly of claim 1 wherein said plurality of drive gear-feed gear pairs is three drive gear-feed gear pairs.

3. The assembly of claim 1 wherein said at least one sieve housing is two sieve housings.

4. The assembly of claim 3 wherein one of said sieve housings is under said top housing and said second sieve housing is under a middle housing.

5. The assembly of claim 1 wherein each of said drive gear-feed gear pairs is functionally attached to said powder feed drive.

6. The assembly of claim 5 wherein said functional attachment is a common drive axle extending from said powder feed drive to each of said drive gear-feed gear pairs.

7. The assembly of claim 1 wherein each of said feed gears includes a plurality of logarithmic vanes and blades from each one of said plurality of logarithmic vanes extend to a floor of each of said housings.

8. The assembly of claim 1 wherein said bottom feed gear includes an offset axis.

9. The assembly of claim 8 wherein said bottom feed gear is housed in an offset housing covers-housings assembly.

10. The assembly of claim 1 further comprising a powder feed hopper attached to said powder feed assembly.

11. An apparatus for die filling with a powder comprising:
a powder dispensing assembly including:
a feed hopper to receive a supply of powder;
a powder feed device operatively attached to said feed hopper;
a dispensing drive mechanism operatively attached to said powder feed device;
a powder feed assembly including:
a plurality of drive gear-feed gear pairs, wherein in each of said pairs each said drive gear is functionally attached to said feed gear;
a plurality of housing covers-housings assemblies wherein each of said plurality of housing covers-housings assemblies holds one of said plurality of drive gear-feed gear pairs and wherein each one of said plurality of housing covers-housings assemblies are stacked one above the other;
at least one sieve housing holding a sieve wherein said housing is attached to one of said housings; and,
a powder feed power drive operatively attached to each of said drive gears
a die; and,
at least one press, wherein said at least one press forms said received powder into said die to form a pellet;
wherein a top feed gear receives powder from said dispensing drive mechanism;
wherein said feed gear feeds said powder to a succeeding feed gear;
wherein said at least one die receives powder from a said at least one sieve; and,
wherein said apparatus is mounted on a base, said base defining at least one die hole.

12. The apparatus of claim 11 wherein each of said at least one die includes a top die and a lower die.

13. The apparatus of claim 11 wherein each of said drive gears is are functionally attached to a common drive axle extending from said powder feed drive and wherein said powder feed dive rotates said common axle in both a clockwise and counterclockwise direction.

14. The apparatus of claim 11 wherein said apparatus is mounted on a plurality of tracks and further comprising a ram system operatively attached to said device and wherein said ram system alternately pulls said apparatus way from said at least one die and pushes said apparatus over said at least one die.

15. The apparatus of claim 11 wherein said dispensing drive mechanism includes vanes to carry said powder from said feed hopper to said powder feed assembly.

16. A method to fabricate pellets from a powder utilizing an apparatus for die filling with a powder, said apparatus comprising:
an apparatus for forming pellets from a powder comprising:
a powder dispensing assembly including:
a feed hopper to receive a supply of powder;
a powder feed device operatively attached to said feed hopper;
a dispensing drive mechanism operatively attached to said powder feed device;
a powder feed assembly including:
a plurality of drive gear-feed gear pairs, wherein in each of said pairs each said drive gear is functionally attached to said feed gear;
a plurality of housing covers-housings assemblies wherein each of said plurality of housing covers-housings assemblies holds one of said plurality of drive gear-feed gear pairs and wherein each one of said plurality of housing covers-housings assemblies are stacked one above the other;
at least one sieve housing holding a sieve wherein said housing is attached to one of said housings; and,
a powder feed power drive operatively attached to each of said drive gears;
wherein said apparatus is mounted on a base, said base defining at least one die hole;
a die; and,
at least one press, wherein said at least one press forms said received powder into said die to form a pellet;
wherein a top feed gear receives powder from said dispensing drive mechanism;
wherein each feed gear feeds said powder to a succeeding feed gear;
wherein said at least one die receives powder from said at least one sieve through said at least one die hole; and,
a ram system operatively attached to said apparatus and wherein said ram system alternately pulls said apparatus way from said at least one die and pushes said apparatus over said at least one die;
wherein a top feed gear receives powder from said dispensing drive mechanism;
wherein each feed gear feeds said powder to a succeeding feed gear;
wherein said at least one die receives powder from said at least one sieve;
said method comprising:
dispensing a known quantity of powder from said powder dispensing assembly into a feed orifice in the top housing of said assembly of housings;
rotating each of said plurality of drive gear-feed gear pairs in both a counterclockwise and clockwise direction;
driving said known quantity of powder through a first sieve into said feed gear of a second drive gear-feed gear pair, said second feed gear positioned under said first sieve;
repeating said rotation of each of said plurality of drive gear-feed gear pairs in both a counterclockwise and clockwise direction;
driving said known quantity of powder through a second sieve into said feed gear of a third drive gear-feed gear pair, said second third feed gear positioned under said second sieve;
repeating said rotation of each of said plurality of drive gear-feed gear pairs in both a counterclockwise and clockwise direction;
driving said known quantity of powder to at least one lower die positioned under said bottom feed gear;
pulling said apparatus from directly above said at least one die using said ram system;
pressing an upper die against said lower die to form a pellet;
raising said lower die/press carrying said pellet; and′
pushing said apparatus to directly above said at least one lower die and simultaneously pushing said formed pellet into a receptacle.

17. The method of claim 16 further comprising driving said known quantity of powder through one or more additional drive gear-feed gear pairs into one or more additional sieves.

18. The method of claim 16 wherein said method is repeated.

19. The method of claim 16 wherein each feed gear comprises vanes and vertical blades extending from said blades to a floor of each of said housings.

20. The method claim 16 wherein said bottom feed gear includes an offset axis.
